(19) United States
(12) Patent Application Publication
(10) Pub. No.: US 2020/0118505 A1
(43) Pub. Date: Apr. 16, 2020

(54) DISPLAY PANEL AND DISPLAY DEVICE

(71) Applicants: HKC Corporation Limited, Shenzhen (CN); Chongqing HKC Optoelectronics Technology Co., Ltd., Chongqing (CN)

(72) Inventor: Zhenli Song, Shenzhen (CN)

(21) Appl. No.: 16/243,063

(22) Filed: Jan. 8, 2019

Related U.S. Application Data
(63) Continuation of application No. PCT/CN2018/115294, filed on Nov. 14, 2018.

(30) Foreign Application Priority Data
Oct. 15, 2018 (CN) 201811199771.2

(51) Int. Cl. G09G 3/36

(52) U.S. Cl. CPC G09G 3/3614; G09G 2330/021; G09G 2300/0443

(57) ABSTRACT

Disclosed is a display panel and a display device. The display panel includes a plurality of pixel groups and a plurality of data lines. The pixel group includes a main pixel and a secondary pixel. The main pixel includes a main sub-pixel, and the secondary pixel includes a secondary sub-pixel.

### RELATED APPLICATION

This application is a Continuation Application of PCT Application No. PCT/CN2018/115294 filed on Nov. 14, 2018, which claims the benefit of a Chinese patent application No. 201811199771.2 titled “DISPLAY PANEL AND DISPLAY DEVICE” applied on Oct. 15, 2018, the disclosure of which is incorporated herein by reference in its entirety.

### FIELD OF THE DISCLOSURE

The present disclosure relates to the field of display technologies, and in particular, to a display panel and a display device.

### BACKGROUND OF THE DISCLOSURE

In the display panel, a change in the lightness of each sub-pixel is controlled by a change in the driving signal on the data line, thereby displaying a certain image. In order to display the correct image while avoiding the phenomena of polarization of the display panel, common voltage excursion, etc., the driving signal on the data line is a high-frequency signal whose polarities change rapidly over time. However, high-frequency driving signals will cause a significant increase in power consumption in the circuit (including chips and lines), which in turn will increase the driving power consumption required for the display panel, and is also prone to safety hazards due to overheating of the circuit.

### SUMMARY OF THE DISCLOSURE

The main object of the present application is to provide a display panel, which aims to solve the technical problem that the frequency of the driving signal on the data line is too high, reduce the driving power consumption of the display panel, and avoid the safety hazard caused by the overheating of the circuit.

In order to achieve the above object, the present application provides a display panel, the display panel includes:

a plurality of pixel groups, the pixel group includes a main pixel and a secondary pixel, the main pixel includes a main sub-pixel, the secondary pixel includes a secondary sub-pixel, and the main sub-pixel and the secondary sub-pixel are arranged in a rectangular array and the main sub-pixel and the secondary sub-pixel on the same column form a sub-pixel column; and

a plurality of data lines, the data lines extend in a longitudinal direction, and the data lines are arranged in a lateral direction, and the data lines and the sub-pixel columns are arranged apart in a lateral direction;

wherein one of the data lines is electrically connected to the main sub-pixel and the secondary sub-pixel having the same driving polarity in two adjacent sub-pixel columns, and one of the main sub-pixels is electrically connected only to one of the data lines and one of the secondary sub-pixels is electrically connected to only one of the data lines.

Optionally, in the same sub-pixel column, the adjacent main sub-pixel and the secondary sub-pixel are electrically connected to different data lines respectively.

Optionally, in the same sub-pixel column, the main sub-pixel is connected to the data line on the left side, and the secondary sub-pixel is connected to the data line on the right side.

Optionally, the two main pixels disposed adjacently in the longitudinal direction are a group of main pixel groups, and the two secondary pixels disposed adjacently in the longitudinal direction are a group of secondary pixel groups. The main pixel group and the secondary pixel group are crosswise arranged in the longitudinal direction.

Optionally, the driving polarities of the driving signals of the two adjacent data lines have opposite driving polarities.

Optionally, a driving polarity of the driving signal on the data line is periodically inverted.

Optionally, the display panel further includes:

a plurality of scanning lines extending in a lateral direction, and the scanning lines are arranged in a longitudinal direction;

In the same main pixel, the main sub-pixels are arranged in a lateral direction and are electrically connected to the same scanning line, and each of the main sub-pixels is electrically connected to a different one of the data lines;

In the same secondary pixel, the secondary sub-pixels are arranged in a lateral direction and are electrically connected to the same scanning line, and each of the secondary sub-pixels is electrically connected to a different one of the data lines.

In order to achieve the above object, the present application further provides a display panel, wherein the display panel includes:

a plurality of pixel groups, the pixel group includes a main pixel and a secondary pixel, the main pixel includes a main sub-pixel, the secondary pixel includes a secondary sub-pixel, and the main sub-pixel and the secondary sub-pixel are arranged in a rectangular array and the main sub-pixel and the secondary sub-pixel on the same column form a sub-pixel column;

a plurality of data lines, the data lines extend in a longitudinal direction, and the data lines are arranged in a lateral direction, and the data lines and the sub-pixel columns are arranged apart in a lateral direction; and

a plurality of scanning lines extending in a lateral direction, and the scanning lines are arranged in a longitudinal direction;

wherein one of the data lines is electrically connected to the main sub-pixel and the secondary sub-pixel having the same driving polarity in two adjacent sub-pixel columns, and one of the main sub-pixels is electrically connected only to one of the data lines and one of the secondary sub-pixels is electrically connected to only one of the data lines;

In the same main pixel, the main sub-pixels are arranged in a lateral direction and are electrically connected to the same scanning line, and each of the main sub-pixels is electrically connected to a different one of the data lines;

In the same secondary pixel, the secondary sub-pixels are arranged in a lateral direction and are electrically connected to the same scanning line, and each of the secondary sub-pixels is electrically connected to a different one of the data lines;

Only a plurality of the main sub-pixels are connected to the same scanning line; alternatively, only a plurality of the secondary sub-pixels are connected to the same scanning line.

In order to achieve the above object, the present application also proposes a display device. The display device includes a display panel and a driving component. The display panel includes a plurality of pixel groups and a plurality of data lines. The pixel group includes a main pixel and a secondary pixel, the main pixel includes a main sub-pixel, the secondary pixel includes a secondary sub-pixel, and the main sub-pixel and the secondary sub-pixel are arranged in a rectangular array and the main sub-pixel and the secondary sub-pixel on the same column form a sub-pixel column; the data lines extend in a longitudinal direction, and the data lines are arranged in a lateral direction, and the data lines and the sub-pixel columns are arranged apart in a lateral direction; wherein one of the data lines is electrically connected to the main sub-pixel and the secondary sub-pixel having the same driving polarity in two adjacent sub-pixel columns, and one of the main sub-pixels is electrically connected only to one of the data lines and one of the secondary sub-pixels is electrically connected to only one of the data lines; the driving component is electrically connected to the data line, and the driving component is used to output a driving signal to the data line.

Optionally, in the same sub-pixel column, the adjacent main sub-pixel and the secondary sub-pixel are electrically connected to different data lines respectively.

Optionally, in the same sub-pixel column, the main sub-pixel is connected to the data line on the left side, and the secondary sub-pixel is connected to the data line on the right side.

Optionally, the two main pixels disposed adjacently in the longitudinal direction are a group of main pixel groups, and the two secondary pixels disposed adjacently in the longitudinal direction are a group of secondary pixel groups. The main pixel group and the secondary pixel group are crosswise arranged in the longitudinal direction.

Optionally, the driving polarities of the driving signals of the two adjacent data lines have opposite driving polarities.

Optionally, a driving polarity of the driving signal on the data line is periodically inverted.

Optionally, the display panel further includes:

a plurality of scanning lines extending in a lateral direction, and the scanning lines are arranged in a longitudinal direction;

In the same main pixel, the main sub-pixels are arranged in a lateral direction and are electrically connected to the same scanning line, and each of the main sub-pixels is electrically connected to a different one of the data lines;

In the same secondary pixel, the secondary sub-pixels are arranged in a lateral direction and are electrically connected to the same scanning line, and each of the secondary sub-pixels is electrically connected to a different one of the data lines.

Optionally, only a plurality of the main sub-pixels are connected to the same scanning line; alternatively, only a plurality of the secondary sub-pixels are connected to the same scanning line.

Optionally, the display device is a television, a computer or a mobile terminal.

In the technical schemes of the present application, the display device includes a display panel and a driving component. The display panel includes a plurality of pixel groups and a plurality of data lines. The pixel group includes a main pixel and a secondary pixel, the main pixel includes a main sub-pixel, the secondary pixel includes a secondary sub-pixel, and the main sub-pixel and the secondary sub-pixel are arranged in a rectangular array and the main sub-pixel and the secondary sub-pixel on the same column form a sub-pixel column; the data lines extend in a longitudinal direction, and the data lines are arranged in a lateral direction, and the data lines and the sub-pixel columns are arranged apart in a lateral direction; wherein one of the data lines is electrically connected to the main sub-pixel and the secondary sub-pixel having the same driving polarity in two adjacent sub-pixel columns, and one of the main sub-pixels is electrically connected only to one of the data lines and one of the secondary sub-pixels is electrically connected to only one of the data lines. During the working process of the display panel, when the main sub-pixels and the secondary sub-pixels having the same driving polarity are connected to the same data line in the adjacent two sub-pixel columns, the polarity of the driving signal on the data line can remain unchanged at least in the duration corresponding to one frame of the display picture. Compared with the case where the main sub-pixel and the secondary sub-pixel of different driving polarities are connected to the same data line, the frequency of the required driving signal is greatly reduced, thereby effectively reducing the driving power consumption of the display panel while reducing the heat generated by the high-frequency driving signal and avoiding the safety hazard caused by the overheating of the circuit.

### BRIEF DESCRIPTION OF THE DRAWINGS

FIG. 1 is a structural view of an exemplary display panel.

FIG. 2 is a schematic diagram of a driving manner of a display panel in an embodiment of the display panel of the present application;

FIG. 3 is a structural view of an embodiment of a display panel of the present application;

FIG. 4 is a structural view of another embodiment of a display panel of the present application;

FIG. 5 is a structural view of the display panel in FIG. 4;

FIG. 6 is a schematic view of the driving manner of the display panel in FIG. 4.

With reference to the drawings, the implement of the object, features and advantages of the present application will be further illustrated in conjunction with embodiments.

### DETAILED DESCRIPTION OF THE EMBODIMENTS

The technical schemes of embodiments of the present disclosure will be clearly and completely described in the following with reference to the accompanying drawings. It is obvious that the embodiments to be described are only a part rather than all of the embodiments of the present disclosure. All other embodiments obtained by persons of ordinary skill in the art based on the embodiments of the present disclosure without creative efforts shall fall within the scope of protection of the present disclosure.

It should be noted that if the embodiments of the present application relates to directional indications (such as up, down, left, right, front, back, . . . ), they are only used to explain the relative positional relationship, motion situation and the like between components in a certain posture (as shown in the drawings), if the specific posture changes, the directional indication shall also change accordingly.

In addition, if the embodiments of the present application relates to the descriptions of “first”, “second” and the like, they are only used for the purpose of description only, and are not to be construed as indicating or implying their relative importance or implicitly indicating the number of technical features indicated. Therefore, the characteristics indicated by the “first”, the “second” can express or impliedly include at least one of the characteristics. In addition, the meaning of “and/or” appearing throughout the text includes three parallel schemes, taking “A and/or B” as an example, including the A scheme, or the B scheme, or the scheme in which both A and B are simultaneously satisfied. In addition, the technical schemes between the various embodiments may be combined with each other, provided that those skilled in the art can implement it, and when the combination of the technical schemes is contradictory or impossible to implement, it should be considered that the combination of these technical schemes does not exist, nor is it within the scope of protection required by this application.

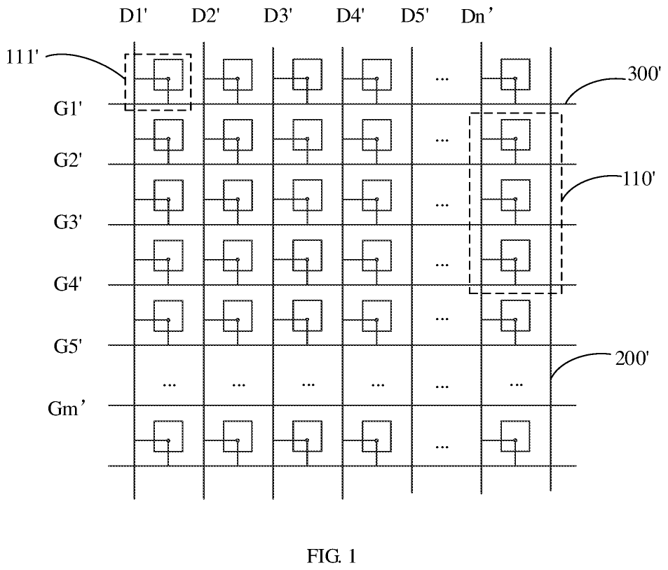

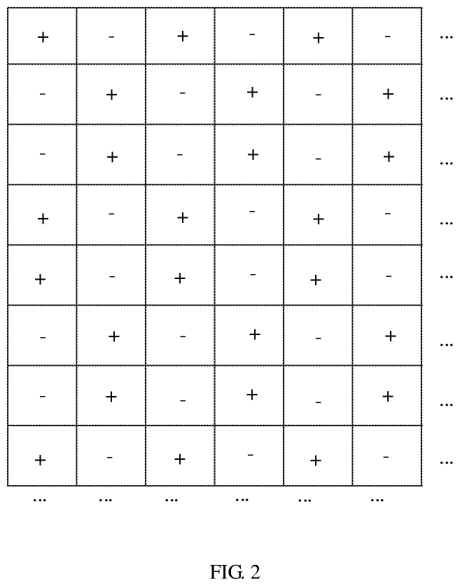

FIG. 1 is a structural view of an exemplary display panel including a plurality of pixels 110′, a plurality of data lines 200′, and a plurality of scanning lines 300′. Among which the pixel 110′ includes a sub-pixel 111′. Generally, one pixel 110′ includes three kinds of sub-pixels 111′, which are red sub-pixels, green sub-pixels, and blue sub-pixels respectively, thereby realizing display of color images by spatial mixed color principle. The sub-pixel 111′ is arranged in a rectangular array, the data line 200′ and the sub-pixel column are arranged apart, and the sub-pixels on the same column are electrically connected to the same data line 200′, and the scanning line 300′ and the sub-pixel row are arranged apart, and the sub-pixels on the same row are electrically connected to the same scanning line 300′. Under the action of the scanning signal Gm′ on the scanning line 300′, each row of sub-pixels 111′ is turned on. When the sub-pixel 111′ is turned on, the sub-pixel 111′ is charged to show a certain lightness under the driving of the driving signal Dn′ on the data line 200′. As shown in FIG. 2 is a driving manner of a specific display panel, wherein FIG. 2 shows driving polarities of driving signals Dn′ applied to the sub-pixels 111′ in adjacent two frames of the display panel, and the display panel is driven by way of a dot inversion or a similar point inversion. For example, in one example, the polarity of the driving signal Dn′ on the data line 200′ may change according to the rule of +−−++−− . . . , or may change according to other rules within a frame time. During the frame time, the driving signal on the data line will undergo multiple polarity inversions, and the frequency of the driving signal Dn′ is high, resulting in the high temperature of the source driver IC.

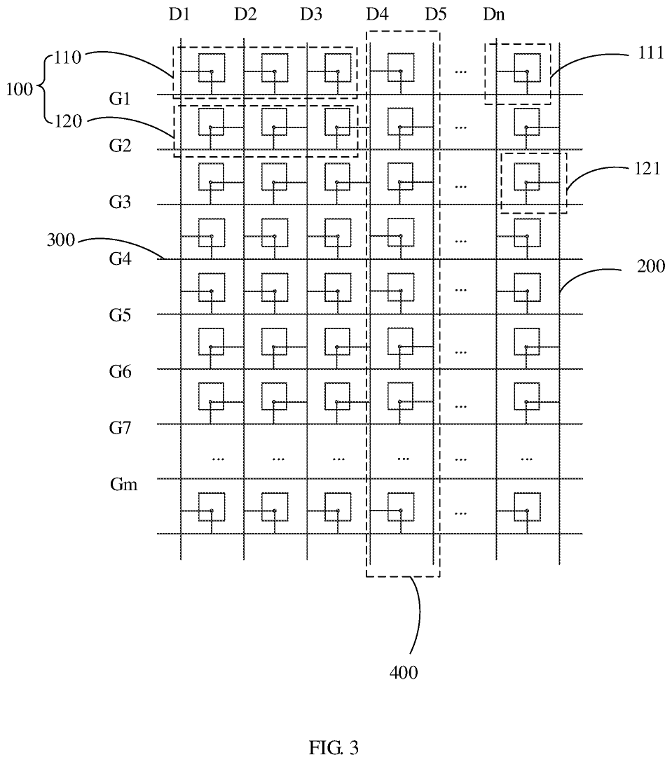

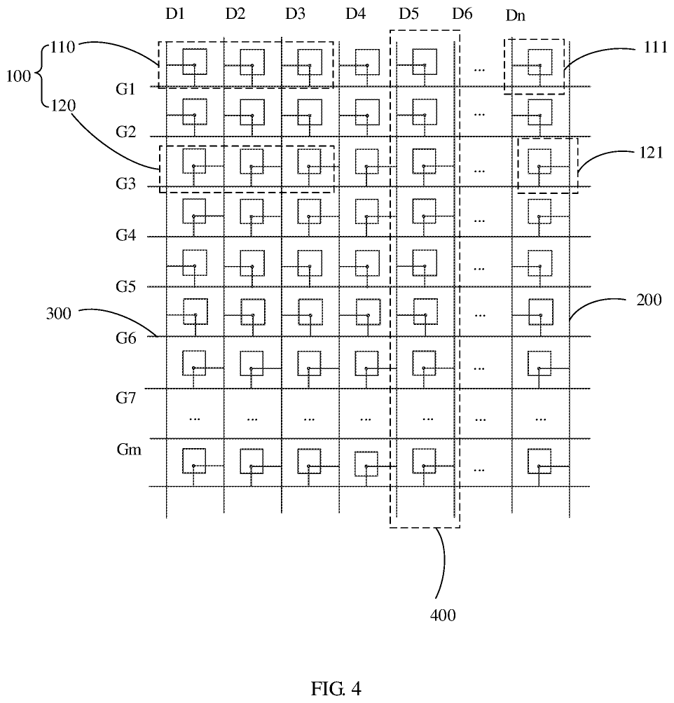

The present application proposes a display panel. In an embodiment of the present application, as shown in FIGS. 3 and 4, the display panel includes a plurality of pixel groups 100 and a plurality of data lines 200. The pixel group 100 includes a main pixel 110 and a secondary pixel 120, the main pixel 110 includes a main sub-pixel 111, the secondary pixel 120 includes a secondary sub-pixel 121, and the main sub-pixel 111 and the secondary sub-pixel 121 are arranged in a rectangular array and the main sub-pixel 111 and the secondary sub-pixel 121 on the same column form a sub-pixel column 400; the data lines 200 extend in a longitudinal direction, and the data lines 200 are arranged in a lateral direction, and the data lines 200 and the sub-pixel columns 400 are arranged apart in a lateral direction; wherein one of the data lines 200 is electrically connected to the main sub-pixel 111 and the secondary sub-pixel 121 having the same driving polarity in two adjacent sub-pixel columns 400, and one of the main sub-pixels 111 is electrically connected only to one of the data lines 200 and one of the secondary sub-pixels 121 is electrically connected to only one of the data lines 200.

The technical schemes of the present application will be described in detail later by taking a liquid crystal display panel as an example. Among which the main sub-pixel or the secondary sub-pixel includes a sub-pixel electrode and a switching device. The switching device includes a source electrode, a drain electrode and a gate electrode. The source electrode is electrically connected to the data line corresponding to the main sub-pixel or the secondary sub-pixel, and the drain electrode is electrically connected to the sub-pixel electrode. Among which the sub-pixel electrode is made of a transparent conductive material such as indium tin oxide (ITO). The data line charges the sub-pixel electrode through the switching device, thereby controlling the liquid crystal deflection to display a certain lightness. Of course, the display panel may further include a common line and a plurality of storage capacitors, and the storage capacitors are disposed in one-to-one correspondence with the sub-pixels to maintain the deflection direction of the liquid crystal to the next frame of image.

In the display panel, each pixel group 100 may include a plurality of main pixels 110 and secondary pixels 120. Without doubt, each pixel group 100 may also include one pixel group 100 including one main pixel 110 and one secondary pixel 120 as an example for description.

Among which the main pixel 110 and the secondary pixel 120 may adopt the same or similar structure, that is, the main pixel 110 includes a main sub-pixel 111, and the secondary pixel 120 includes a secondary sub-pixel 121. Generally, the main pixel 110 includes three main sub-pixels, which are a red main sub-pixel, a green main sub-pixel, and a blue main sub-pixel respectively, and are arranged according to a certain rule. Similarly, the secondary pixel 120 includes three secondary sub-pixels, which are a red secondary sub-pixel, a green secondary sub-pixel, and a blue secondary sub-pixel respectively, and are arranged according to a certain rule to realize the display of the color picture. Among which the main sub-pixel 111 and the secondary sub-pixel 121 are arranged in a rectangular array from the entirety of the display panel, and the main sub-pixel 111 and the secondary sub-pixel 121 on the same column form a sub-pixel column 400, and are arranged apart with the data lines 200 extending in the longitudinal direction in order to realize the electrical connection between the data line 200 and the main sub-pixel 111 and the secondary sub-pixel 121, reducing the occurrence of the overline condition. In order to reduce the polarity inversion frequency of the driving signal Dn on the data line 200, that is, to reduce the frequency of the driving signal Dn, the data line 200 is electrically connected to the main sub-pixel 111 and the secondary sub-pixel 121 having the same polarity in the adjacent sub-pixel columns 400. At the same time, one of the main sub-pixels 111 is electrically connected only to one of the data lines 200, and one of the secondary sub-pixels 121 is electrically connected only to one of the data lines 200, so as to prevent a driving confusion caused by a plurality of data lines controlling the same sub-pixel. When the main sub-pixel 111, the secondary sub-pixel 121, and the data line 200 are connected in the above manner, the polarity of the driving signal Dn on the data line 200 will change according to the rules of ++++++++++ . . . or −−−−−−−−−−− . . . within one frame time if the display panel is driven by the driving method described in FIG. 2. That is to say, the polarity of the driving signal on the data line 200 does not change within a duration of time corresponding to one frame, thereby reducing the frequency of the driving signal, reducing the heat generated in the circuit, thereby reducing the display power consumption of the display panel while avoiding the safety hazard caused by overheating of the circuit. Without doubt, at the time of frame conversion, the polarity of the driving signal Dn on the data line 200 can be inverted to avoid polarization of the display panel and excursion of the common voltage.

In the present embodiment, the display panel includes a plurality of pixel groups 100 and a plurality of data lines 200. The pixel group 100 includes a main pixel 110 and a secondary pixel 120, the main pixel 110 includes a main sub-pixel 111, the secondary pixel 120 includes a secondary sub-pixel 121, and the main sub-pixel 111 and the secondary sub-pixel 121 are arranged in a rectangular array and the main sub-pixel 111 and the secondary sub-pixel 121 on the same column form a sub-pixel column 400; the data lines 200 extend in a longitudinal direction, and the data lines 200 are arranged in a lateral direction, and the data lines 200 and the sub-pixel columns 400 are arranged apart in a lateral direction; wherein one of the data lines 200 is electrically connected to the main sub-pixel 111 and the secondary sub-pixel 121 having the same driving polarity in two adjacent sub-pixel columns 400, and one of the main sub-pixels 111 is electrically connected only to one of the data lines 200 and one of the secondary sub-pixels 121 is electrically connected to only one of the data lines 200. During the working process of the display panel, the driving signals on the data line 200 charge the main sub-pixel 111 and the secondary sub-pixel 121 to control the lightness of the main sub-pixel 111 and the secondary sub-pixel 121. Among which, when the main sub-pixels 111 and the secondary sub-pixels 121 having the same driving polarity are connected to the same data line in the adjacent two sub-pixel columns 400, the polarity of the driving signal on the data line 200 can remain unchanged at least in the duration corresponding to one frame of the display picture. Compared with the case where the main sub-pixel 111 and the secondary sub-pixel 121 of different driving polarities are connected to the same data line 200, the frequency of the required driving signal is greatly reduced, thereby effectively reducing the driving power consumption of the display panel while reducing the heat generated by the high-frequency driving signal and avoiding the safety hazard caused by the overheating of the circuit.

Further, in the same sub-pixel column 400, the adjacent main sub-pixel 111 and the secondary sub-pixel 121 are electrically connected to different data lines 200 respectively. In the case shown in FIG. 3, the main sub-pixel 111 and the main sub-pixel 121 on each column and adjacent to each other are connected to different data lines 200. By controlling the electrical connection of the adjacent main sub-pixel 111 and the secondary sub-pixel 121 to different data lines 200 respectively, the display panel is driven by the dot inversion in units of the main pixel 110 or the secondary pixel 120, thereby facilitating to avoid the polarization of the display panel, reducing the excursion of the common voltage, and improving the display effect of the display panel.

In the same sub-pixel column 400, the main sub-pixel 111 is connected to the data line 200 on the left side, and the secondary sub-pixel 121 is connected to the data line 200 on the right side. That is to say, all of the main sub-pixels 111 are connected to the data lines 200 located on the left side of the main sub-pixel 111, and all of the secondary sub-pixels 121 are connected to the data lines 200 located on the right side of the secondary sub-pixel 121. Thereby, the main sub-pixel 111 and the sub-sub-pixel 121 are better distinguished.

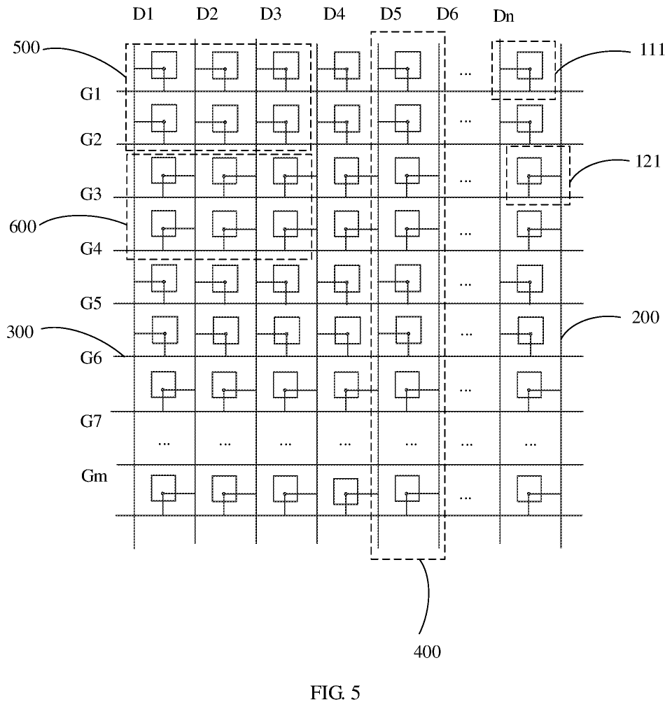

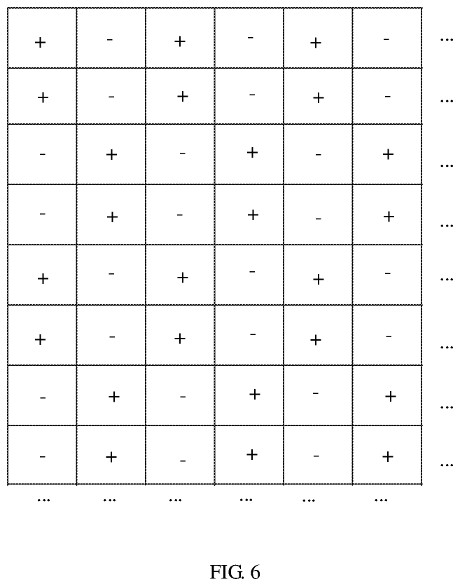

As shown in FIGS. 4 to 6, the two main pixels 110 disposed adjacently in the longitudinal direction are a group of main pixel groups 500, and the two secondary pixels 120 disposed adjacently in the longitudinal direction are a group of secondary pixel groups 600. The main pixel group 500 and the secondary pixel group 600 are crosswise arranged in the longitudinal direction. In the present embodiment, the upper and lower adjacent pixels of the two main pixels 110 are all the secondary pixels 120, and the upper and lower adjacent pixels of the two secondary pixels 120 are the main pixels 110. Of course, in other specific examples, the display panel may be divided into different display areas according to the viewing angle, and the pixel group 100 including the main pixel 110 and the secondary pixel 120 may be disposed in the display area corresponding to the oblique viewing angle; In the display area, each pixel is driven directly in the manner shown in the example; each pixel is directly driven in the manner shown in the example in the display area corresponding to the positive viewing angle.

In the display panel, driving polarities of driving signals on two adjacent data lines 200 are opposite. For example, when the polarity of the driving signal on one of the data lines 200 is +, the polarity of the left and right data lines 200 adjacent to the data line 200 having the polarity of + is −. At the same time, driving polarities of driving signal Dn on the data line 200 is periodically inverted, and the inversion period may be an integer multiple of the period corresponding to the frame rate of the display panel, so as to realize the inversion between frames, thereby avoiding the polarization generated in the display panel, reducing the excursion of the common voltage, and improving the display effect of the display panel.

In an embodiment of the present application, the display panel further includes a plurality of scanning lines 300. The scanning lines 300 extend in a lateral direction, and the scanning lines 300 are arranged in a longitudinal direction; in the same main pixel 110, the main sub-pixels 111 are arranged in the lateral direction and are electrically connected to the same scanning line 300, and each of the main sub-pixels 111 is electrically connected to a different data line 200; in the same sub-pixel 120, the secondary sub-pixels 121 are arranged in the lateral direction and are electrically connected to the same scanning line 300, and each secondary sub-pixel 121 is electrically connected to a different data line 200. In the present embodiment, each sub-pixel in each pixel is arranged in a lateral direction, and at least two data lines are required to achieve the drive respectively corresponding to each pixel (as shown is three data lines driving three sub-pixels respectively), and each sub-pixel in the same pixel shares a scanning line. Since the sub-pixels are in one-to-one correspondence with the data lines in one pixel, it is beneficial to further reduce the frequency of the driving signal Dn on the data line, thereby reducing circuit power consumption and thermal effects, and giving the sub-pixels sufficient charging time and improving the display effect of the display panel.

Further, in the adjacent pixel group 100, the driving polarities of the main sub-pixel 110 or the secondary sub-pixel 120 at respective corresponding positions are opposite. That is to say, in the present embodiment, the display panel is driven in a dot inversion manner in units of the pixel group 100 to avoid polarization of the display panel and to reduce the excursion of the common voltage. While in the two adjacent pixel groups 100, the driving polarities of the main sub-pixels and the main sub-pixels having the opposite relative positions are opposite, and the driving polarities of the secondary sub-pixels and the secondary sub-pixels having the same relative positions are opposite.

Further, only a plurality of main sub-pixels 111 are connected to the same scanning line 300; alternatively, only a plurality of the secondary sub-pixels 121 are connected to the same scanning line 300. Specifically, only a plurality of main sub-pixels 111 are provided on the scanning line and on the other same line, only a plurality of the secondary sub pixels 121 are provided.

In another embodiment of the present application, the display panel further includes a plurality of scanning lines 300. The scanning lines 300 extend in a lateral direction, and the scanning lines 300 are arranged in a longitudinal direction; in the same main pixel 110, the main sub-pixels 111 are arranged in the longitudinal direction and are electrically connected to the same scanning line 200, and each of the main sub-pixels 111 is electrically connected to a different data line 300; in the same sub-pixel 120, the secondary sub-pixels 121 are arranged in the longitudinal direction and are electrically connected to the same scanning line 200, and each secondary sub-pixel 121 is electrically connected to a different data line 300. In the present embodiment, each sub-pixel in each pixel is arranged in a longitudinal direction, and at least two scanning lines are required to achieve the drive respectively corresponding to each pixel, and each sub-pixel in the same pixel shares a data line. Since the cost of the scanning lines in the display panel is often lower than that of the data lines, this driving method can reduce the number of data lines required in the display panel, thereby reducing the cost of the display panel.

The present application further proposes a display device including a display panel and a driving component. The driving component is electrically connected to the data line, and the driving component is configured to output a driving signal to the data line. The specific structure of the display panel can be understood with reference to the foregoing embodiments and details are not described herein again. The display device may specifically be a liquid crystal television, a mobile phone, a computer, and other electronic devices having a display, etc., which is not limited in the present application.

The embodiments above are merely preferably embodiments of the present disclosure but are not to be construed as limiting the scope of the present disclosure, and any equivalent structural conversion devised based on the inventive concept of the present disclosure or using the drawing of the present disclosure, or a direct or indirect application of the present disclosure to another related technical field shall fall into the scope of protection of the present disclosure.

What is claimed is:

1. A display panel, comprising:
a plurality of pixel groups, the pixel group includes a main pixel and a secondary pixel, the main pixel includes a main sub-pixel, the secondary pixel includes a secondary sub-pixel, and the main sub-pixel and the secondary sub-pixel are arranged in a rectangular array and the main sub-pixel and the secondary sub-pixel on the same column form a sub-pixel column; and
a plurality of data lines, the data lines extend in a longitudinal direction, and the data lines are arranged in a lateral direction, and the data lines and the sub-pixel columns are arranged apart in a lateral direction;
wherein one of the data lines is electrically connected to the main sub-pixel and the secondary sub-pixel having the same driving polarity in two adjacent sub-pixel columns, and one of the main sub-pixels is electrically connected only to one of the data lines and one of the secondary sub-pixels is electrically connected to only one of the data lines.

2. The display panel according to claim 1, wherein in the same sub-pixel column, the adjacent main sub-pixel and the secondary sub-pixel are electrically connected to different data lines respectively.

3. The display panel according to claim 2, wherein in the same sub-pixel column, the main sub-pixel is connected to the data line on the left side, and the secondary sub-pixel is connected to the data line on the right side.

4. The display panel according to claim 3, wherein the two main pixels disposed adjacently in the longitudinal direction are a group of main pixel groups, and the two secondary pixels disposed adjacently in the longitudinal direction are a group of secondary pixel groups. The main pixel group and the secondary pixel group are crosswise arranged in the longitudinal direction.

5. The display panel according to claim 1, wherein the driving polarities of the driving signals of the two adjacent data lines have opposite driving polarities.

6. The display panel according to claim 5, wherein a driving polarity of the driving signal on the data line is periodically inverted.

7. The display panel according to claim 1, wherein the display panel further comprises:
a plurality of scanning lines extending in a lateral direction, and the scanning lines are arranged in a longitudinal direction;
In the same main pixel, the main sub-pixels are arranged in a lateral direction and are electrically connected to the same scanning line, and each of the main sub-pixels is electrically connected to a different one of the data lines;
In the same secondary pixel, the secondary sub-pixels are arranged in a lateral direction and are electrically connected to the same scanning line, and each of the secondary sub-pixels is electrically connected to a different one of the data lines.

8. The display panel according to claim 2, wherein the display panel further comprises:
a plurality of scanning lines extending in a lateral direction, and the scanning lines are arranged in a longitudinal direction;
In the same main pixel, the main sub-pixels are arranged in a lateral direction and are electrically connected to the same scanning line, and each of the main sub-pixels is electrically connected to a different one of the data lines;
In the same secondary pixel, the secondary sub-pixels are arranged in a lateral direction and are electrically connected to the same scanning line, and each of the secondary sub-pixels is electrically connected to a different one of the data lines.

9. The display panel according to claim 3, wherein the display panel further comprises:
a plurality of scanning lines extending in a lateral direction, and the scanning lines are arranged in a longitudinal direction;
In the same main pixel, the main sub-pixels are arranged in a lateral direction and are electrically connected to the same scanning line, and each of the main sub-pixels is electrically connected to a different one of the data lines;
In the same secondary pixel, the secondary sub-pixels are arranged in a lateral direction and are electrically connected to the same scanning line, and each of the secondary sub-pixels is electrically connected to a different one of the data lines.

10. The display panel according to claim 4, wherein the display panel further comprises:
a plurality of scanning lines extending in a lateral direction, and the scanning lines are arranged in a longitudinal direction;
In the same main pixel, the main sub-pixels are arranged in a lateral direction and are electrically connected to the same scanning line, and each of the main sub-pixels is electrically connected to a different one of the data lines;
In the same secondary pixel, the secondary sub-pixels are arranged in a lateral direction and are electrically connected to the same scanning line, and each of the secondary sub-pixels is electrically connected to a different one of the data lines.

11. A display panel, wherein the display panel further comprises:
a plurality of pixel groups, the pixel group includes a main pixel and a secondary pixel, the main pixel includes a main sub-pixel, the secondary pixel includes a secondary sub-pixel, and the main sub-pixel and the secondary sub-pixel are arranged in a rectangular array and the main sub-pixel and the secondary sub-pixel on the same column form a sub-pixel column;
a plurality of data lines, the data lines extend in a longitudinal direction, and the data lines are arranged in a lateral direction, and the data lines and the sub-pixel columns are arranged apart in a lateral direction; and
a plurality of scanning lines extending in a lateral direction, and the scanning lines are arranged in a longitudinal direction;
wherein one of the data lines is electrically connected to the main sub-pixel and the secondary sub-pixel having the same driving polarity in two adjacent sub-pixel columns, and one of the main sub-pixels is electrically connected only to one of the data lines and one of the secondary sub-pixels is electrically connected to only one of the data lines;
In the same main pixel, the main sub-pixels are arranged in a lateral direction and are electrically connected to the same scanning line, and each of the main sub-pixels is electrically connected to a different one of the data lines;
In the same secondary pixel, the secondary sub-pixels are arranged in a lateral direction and are electrically connected to the same scanning line, and each of the secondary sub-pixels is electrically connected to a different one of the data lines;
Only a plurality of the main sub-pixels are connected to the same scanning line; alternatively, only a plurality of the secondary sub-pixels are connected to the same scanning line.

12. A display device, wherein the display device comprises a display panel and a driving component, the display panel comprising:
a plurality of pixel groups, the pixel group includes a main pixel and a secondary pixel, the main pixel includes a main sub-pixel, the secondary pixel includes a secondary sub-pixel, and the main sub-pixel and the secondary sub-pixel are arranged in a rectangular array and the main sub-pixel and the secondary sub-pixel on the same column form a sub-pixel column; and
a plurality of data lines, the data lines extend in a longitudinal direction, and the data lines are arranged in a lateral direction, and the data lines and the sub-pixel columns are arranged apart in a lateral direction;
wherein one of the data lines is electrically connected to the main sub-pixel and the secondary sub-pixel having the same driving polarity in two adjacent sub-pixel columns, and one of the main sub-pixels is electrically connected only to one of the data lines and one of the secondary sub-pixels is electrically connected to only one of the data lines;
The driving component is electrically connected to the data line, and the driving component is used to output a driving signal to the data line.

13. The display device according to claim 12, wherein in the same sub-pixel column, the adjacent main sub-pixel and the secondary sub-pixel are electrically connected to different data lines respectively.

14. The display device according to claim 13, wherein in the same sub-pixel column, the main sub-pixel is connected to the data line on the left side, and the secondary sub-pixel is connected to the data line on the right side.

15. The display device according to claim 14, wherein the two main pixels disposed adjacently in the longitudinal direction are a group of main pixel groups, and the two secondary pixels disposed adjacently in the longitudinal direction are a group of secondary pixel groups. The main pixel group and the secondary pixel group are crosswise arranged in the longitudinal direction.

16. The display device according to claim 12, wherein the driving polarities of the driving signals of the two adjacent data lines have opposite driving polarities.

17. The display device according to claim 16, wherein a driving polarity of the driving signal on the data line is periodically inverted.

18. The display device according to claim 12, wherein the display panel further comprises:
a plurality of scanning lines extending in a lateral direction, and the scanning lines are arranged in a longitudinal direction;
In the same main pixel, the main sub-pixels are arranged in a lateral direction and are electrically connected to the same scanning line, and each of the main sub-pixels is electrically connected to a different one of the data lines;
In the same secondary pixel, the secondary sub-pixels are arranged in a lateral direction and are electrically connected to the same scanning line, and each of the secondary sub-pixels is electrically connected to a different one of the data lines.

19. The display device according to claim 18, wherein only a plurality of the main sub-pixels are connected to the same scanning line; alternatively, only a plurality of the secondary sub-pixels are connected to the same scanning line.

20. The display device of claim 12, wherein the display device is a television, a computer or a mobile terminal.
